(19) United States
(12) Patent Application Publication
(10) Pub. No.: US 2010/0124607 A1
(43) Pub. Date: May 20, 2010

(54) Adhesive Compositions And Methods Of Making The Same

(76) Inventors: Douglas A. Berti, Houston, TX (US); David R. Johnsrud, Humble, TX (US); Patrick S. Byrne, Baton Rouge, LA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/604,874

(22) Filed: Oct. 23, 2009

Related U.S. Application Data
(60) Provisional application No. 61/116,059, filed on Nov. 19, 2008.

(51) Int. Cl. B05D 5/10

(52) U.S. Cl. 427/207.1

(57) ABSTRACT

Provided are methods for preparing agglomeration resistant particles composed of tacky polymer compositions. The method includes the steps of providing particles of the polymer composition at or above the glass transition temperature of the polymer composition, increasing the tackiness of the polymer composition particles by contacting the polymer composition particle with a first fluid at an elevated temperature, while the polymer composition particles are in contact with the first fluid, contacting the polymer composition particles with an antiblock composition, and separating the polymer composition particles from the first fluid. These methods at least partially coat the polymer composition particles with the antiblock composition.

### PRIORITY CLAIM

This application claims priority to and the benefit of U.S. Ser. No. 61/116,059, filed Nov. 19, 2008.

### FIELD OF THE INVENTION

This invention relates to adhesive compositions, methods of making the same, and more particularly to agglomeration resistant particles composed of normally tacky plastic materials such as polyolefins and adhesives based thereon.

### BACKGROUND

Conventional polymeric compounds that are inherently “soft and tacky” such as certain polyolefins and adhesives based thereon are difficult to process into pellets by conventional pelletization methods. Conventional materials generally have a low degree of crystallinity and solidify slowly. These materials will either gum up or smear on processing equipment, such as rotary knives of pelletizers. Soft and tacky materials also plug conveying lines and/or agglomerate after being stored for a short period of time, particularly at elevated temperatures. These materials must then be produced and sold in some other less desirable form, such as large solid blocks, powder coated slats, or large volume drums. It would, therefore, be desirable if a process could be developed to produce free flowing particles of these soft and tacky materials.

Pelletized adhesive compositions not only stick or adhere to hands and mechanical handling devices, but also adhere to dirt and other contaminates. As a result, containment during shipment and/or storage periods is a critical aspect for commercial adhesives, or any kind of sticky plastic materials.

In some cases adhesive compositions cannot be shipped as bulk pellets. For example, transportation of pellets in hopper rail cars is not possible because of the risk of agglomerating into a huge mass that will not readily flow out of the hopper car. It is common practice to use cooled, insulated rail cars to facilitate unloading of soft and/or tacky pellets from the cars because the pellets are less soft and tacky at cooler temperatures. For example, ethylene-vinyl acetate (EVA) copolymers are used as adhesives in hot melt adhesive applications. Typically, as vinyl acetate content increases, EVA pellets become softer, tackier, and more prone to agglomeration under their own weight. This inhibits handling of polymer pellets. Accordingly, prior to use the pellets must be forcibly re-dispersed to enable the pellets to flow. Such agglomeration of pellets disrupts end-use operations.

Various conventional techniques have been proposed to prevent soft and/or tacky compositions from agglomerating, including pelletizing the composition and dusting the pellets with various materials. Due to loss of the dust during transport and storage, incorporation of additives into some tacky compositions has been a preferred method of reducing agglomeration. Unfortunately, modifying the composition of tacky compositions is not always a feasible or desirable alternative to dusting techniques.

Accordingly, there is a need for methods of preparing tacky composition particles that resist agglomeration at ambient or elevated temperature and thereby provide an economic means of transportation and storage.

### SUMMARY

Provided are methods for preparing agglomeration resistant particles composed of tacky polymer compositions. The method includes the steps of providing particles of the polymer composition at or above the glass transition temperature of the polymer composition, increasing the tackiness of the polymer composition particles by contacting the polymer composition particle with a first fluid at an elevated temperature, while the polymer composition particles are in contact with the first fluid, contacting the polymer composition particles with an antiblock composition, and separating the polymer composition particles from the first fluid. These methods at least partially coat the polymer composition particles with the antiblock composition.

In contrast to conventional techniques which coat cooled particles with an antiblock combination, the present methods counter-intuitively increase the temperature of tacky particles before contacting them with antiblock compositions. The present methods yield particles that are resistant to agglomeration, even at elevated storage and transportation temperatures, such as 50° C. and above. Thus, particles remain substantially free-flowing even under temperatures, storage times, and compression which might otherwise facilitate caking or agglomeration.

### BRIEF DESCRIPTION OF THE DRAWINGS

FIG. 1 is an exemplary schematic diagram of an apparatus for preparing agglomeration resistant particles.

FIG. 2 is a graph of crystallization half-life vs. temperature obtained by isothermal DSC testing of compositions prepared according to the present methods.

FIG. 3 is an X-Y graph of hardness vs. time for pellets immersed in water and prepared according to the present methods.

FIG. 4 is an X-Y graph of hardness vs. time for pellets aged in air and prepared according to the present methods.

FIG. 5 is a graph of extent of agglomeration vs. temperature for polymers prepared according to the present methods.

FIG. 6 is an exemplary schematic diagram of an apparatus for preparing agglomeration resistant particles.

### DETAILED DESCRIPTION OF ILLUSTRATIVE EMBODIMENTS

Provided are methods for preparing agglomeration resistant particles, particles made from such methods, and apparatus for performing such methods. The provided methods are useful for preparing agglomeration resistant particles composed of tacky compositions, such as adhesives or polymers. The methods include the steps of contacting tacky composition particles with a first fluid at an elevated temperature, and while the tacky composition is in contact with the first fluid, contacting the tacky composition with an antiblock composition. These methods substantially coat the tacky composition with the antiblock composition.

In contrast to conventional techniques which coat cooled particles with an antiblock combination, the present methods counter-intuitively increase the temperature of tacky particles before contacting them with antiblock compositions. The present methods yield particles that are resistant to agglomeration, even at elevated storage and transportation temperatures, such as 50° C. and above. Thus, particles remain substantially free-flowing even under temperatures, storage times, and compression which might otherwise facilitate caking or agglomeration. Accordingly, the present methods are useful for unitizing tacky compositions.

Although conventional pelletizing processes teach improved results and ease of pelletizing at low tacky composition temperatures, e.g., below the Ring and Ball Softening Point, such processes suffer from disadvantages, such as: (a) not producing pourable particles, (b) requiring more than one coating step, (c) requiring a dusting step thereby creating potential airborne hazards (d) requiring modification in tacky composition, i.e., compromising composition, to achieve particles that resist agglomeration, (e) increased risk of phase separation or die freeze-off resulting from operating at or near crystallization or Ring and Ball softening temperatures during extrusion/pelletization, (f) abnormal pellet formation, i.e., extruded material wrapping around a die face by cutting apparatus, elongated pellets, and formation of poor geometry pellets, and/or (g) requiring additional equipment, e.g., pumps, or mechanical energy to maintain flow rates.

Such conventional methods and compositions are described in U.S. Pat. Nos. 7,328,547, 7,232,535, 7,137,235, 7,122,584, 7,101,926, 6,716,527, 6,616,968, 6,533,564, 6,458,300, 6,426,026, 6,335,095, 6,228,902, 6,120,899, 6,177,516, 5,942,304, 5,895,617, 5,733,645, 5,695,881, 5,650,370, 5,629,050, 5,609,892, 5,594,074, 5,403,528, 5,143,673, 5,041,251, and 4,897,452, each of which is herein fully incorporated by reference.

Conventional methods and compositions are also described in U.S. Patent Publication Nos. 2007/0270538, 2006/0093764, 2004/0209082, and 2002/0033131, each of which is herein fully incorporated by reference.

### Tacky Compositions

Tacky compositions are compositions that are difficult to unitize due to the tendency to agglomerate or cake. Tacky compositions include waxes, adhesives, polymers, e.g., high melt-flow polyolefins, elastomers, hydrocarbon resins, and non-polymeric organic and/or inorganic compounds. For example, tacky compositions include polymer composition having an unconfined yield strength of at least about 15 lbs/ft² at or above 25° C. as measured by ASTM D6773.

Typical tacky compositions include:

polyolefins, e.g., polyalphaolefins, maleated polyolefins, oxidized polyolefins,
polyethylenes, e.g., ethylene-acrylic acid copolymers, ethylene-cyclopentadiene copolymers, ethylene-methacrylate copolymers, ethylene-propylene monomer or EPM, ethylene-propylene-diene monomer or EPDM, ethylene-vinyl acetate copolymers, ethylene-vinyl alcohol copolymers, high density polyethylene, low density polyethylene, very low density polyethylene, linear low density polyethylene, or ethylene higher alpha-olefin copolymers;
polypropylenes, including soft polypropylene (either homopolymers, co- or ter-polymers), random copolymers, impact copolymers (ICP), or heterophasic polypropylene and thermoplastic vulcanized or TPV-based polypropylene;
polybutenes, including poly 1-butene homopolymers and copolymers or polyisobutylene;

styrenic compositions, e.g., polystyrene, styrene butadiene styrene or SBS, styrene ethylene butylene block copolymers (SEBS), styrene ethylene propylene block copolymers (SEPS), styrene-isoprene-styrene or SIS, acrylonitrile-butadiene-styrene elastomers and high impact polystyrene (HIPS);

rubbers, e.g., butadiene rubber, crumb rubber, halobutyl rubber, isobutylene rubber, isobutylene—isoprene copolymeric rubber, natural rubber, nitrile or hydrogenated nitrile rubber, styrene butadiene rubber or SBR, styrene-isoprene rubber or SIR, styrene-isoprene—butadiene rubber or SIBR, ethylene acrylates co- and ter-polymer rubbers, chloroprene rubber, chlorinated polyethylene, chloro-sulfonated polyethylene, acrylic rubber, epichlorhydrin rubber, propylene oxide rubber, fluorinated elastomers, polysiloxanes or silicone rubber, polyurethane rubber,
thermoplastic olefin elastomers—unvulcanized (TPO), thermoplastic olefin elastomers—vulcanized (TPE), polypropylene cross-linked EPDM rubber blends, thermoplastic nitrile elastomers, thermoplastic chloroolefin elastomers, thermoplastic polyurethane elastomers, thermoplastic copolyesters, thermoplastic copolyamides, thermoplastic copolyethers;
chocolate,
latex, e.g., natural or liquid latexes,
polyamides, e.g., polyacrylamides,
polyacrylates, polyacrylonitriles,
polycarbonates,
polyesters including PET and PBT,

and others including polyisoprene, polynorbornenes, polysilicates, polyurethane, polyvinylacetate or PVA or PVAc, polyvinyl alcohol, vinyl acetate homopolymer, vinyl acetate—vinyl laurate copolymers,

or blends thereof.

Typical composition characteristics that result in difficulty in processing and/or unitization include one or more of: a very narrow melting range, a low temperature melting range, a low viscosity of molten or semi-solid materials, slow thermal conductivity and therefore slow ability to cool rapidly enough for processing, proclivity to undergo phase separation on cooling, surface tack, poor miscibility of liquids during blending processes, and extreme temperature variance from mixing/blending stages to finishing/unitization stages. Pelletization of these materials via conventional processes may gum-up or smear-on the rotary knives and surfaces of the die or block of an extrusion apparatus.

Polypropylene, or propylene polymers, are polymers composed of propylene monomers. As used herein “polypropylene”, “polypropylene polymer(s)”, or “propylene polymer(s)” mean homopolymers, copolymers, terpolymers, higher order copolymers, or interpolymers made from propylene derived units, or combinations thereof.

As used herein “homopolymer” means polymers resulting from the polymerization of a single monomer, i.e., a polymer consisting essentially of a single type of repeating unit.

As used herein, the term “copolymer(s)” refers to polymers formed by the polymerization of at least two different monomers. For example, the term “copolymer” includes the copolymerization reaction product of propylene and an α-olefin, such as for example, 1-hexene.

“Polypropylene” includes stereoregular polypropylene, stereoregular polypropylene segments separated by amorphous polypropylene, amorphous polypropylene, polypropylene copolymers, polypropylene terpolymers, and higher order polypropylene copolymers. As used herein “stereoregular polypropylene” means stereoregular propylene sequences long enough to crystallize under conditions known to those skilled in the art.

Polypropylene also includes heterophasic polypropylene which are blends of polypropylene and an elastomer. These are either produced in a single polymerization process involving the use of series reactors where the polypropylene component is produced in the first reactor and one or 2 other ethylene copolymers are produced in a second and eventually a third reactor or in a process where the polypropylene component and the rubber component are blended in a post polymerization process. Those produced in a polymerization process are usually called ICP (Impact copolymer) and those produce in a blending process are called TPO (thermoplastic olefin). In certain cases the dispersed rubber phase can vulcanized and these blends are called TPV (thermoplastic vulcanizates) or DVA (dynamically vulcanized Alloys).

Preferably, polypropylene polymers are propylene-based copolymer, i.e., propylene copolymer, which may also be referred to as a propylene-α-olefin copolymer. Propylene copolymer includes one or more units, i.e., mer units, derived from propylene, one or more comonomer units derived from ethylene or α-olefins including from 4 to about 20 carbon atoms. Optionally one or more comonomer units derive from dienes.

In one or more embodiments, the α-olefin comonomer units derive from ethylene, 1-butene, 1-hexane, 4-methyl-1-pentene and/or 1-octene. Exemplary alpha-olefins are selected from the group consisting of ethylene, butene-1, pentene-1,2-methylpentene-1,3methylbutene-1, hexene-1,3-methylpentene-1,4-methylpentene-1,3,3-dimethylbutene-1, heptene-1, hexene-1, methylhexene-1, dimethylpentene-1, trimethylbutene-1, ethylpentene-1, octene-1, methylpentene-1, dimethylhexene-1, trimethylpentene-1, ethylhexene-1, methylethylpentene-1, diethylbutene-1, propylpentane-1, decene-1, methylnonene-1, nonene-1, dimethyloctene-1, trimethylheptene-1, ethyloctene-1, methylethylbutene-1, diethylhexene-1, dodecene-1, and hexadodecene-1.

Exemplary diene comonomer units include 5-ethylidene-2-norbornene, 5-vinyl-2-norbornene, divinyl benzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, and dicyclopentadiene.

Propylene polymers may include from about 1 weight percent (wt. %) to about 50 wt. % of α-olefin comonomers, based on the weight of the propylene copolymer. Preferably, propylene copolymers include from about 1 wt. % to about 35 wt. %, from 1 wt. % to about 30 wt. %, from about 1 wt. % to about 25 wt. %, or from about 1 wt. % to about 20 wt. % of α-olefin comonomers. More preferably, propylene copolymers include from about 1 wt. % to about 18 wt. %, from about 1 wt. % to about 16 wt. % of α-olefin comonomers. Still more preferably, propylene copolymers include from about 1 wt. % to about 12 wt. %, no more than about 8 wt. % of α-olefin comonomers. In one or more embodiments propylene copolymers include from about 3.0 to about to about 7.0 wt. % of α-olefin comonomers. In other embodiments, propylene copolymers include from about 4 to about 6 wt. % of α-olefin comonomers. In still other embodiments, propylene copolymers include from about 1 to about 5 wt. % or from about 3 to about 5 wt. % of α-olefin comonomers.

In some embodiments, polypropylenes have a melt index in dg/min (“MI”), according to ASTM D-1238 at 2.16 kg and 190° C., of not more than about 10, or not more than about 6.5, or not more than about 6, or not more than about 5.5, and in other embodiments not more than about 5.

In some embodiments, the melt flow rate (“MFR”) of polypropylenes, as measured according to ASTM D-1238 at 2.16 kg weight and 230° C., is at least about 0.2 dg/min, or of at least about 0.2 dg/min, or at least about 0.5 dg/min, and in other embodiments at least about 1.0 dg/min. Polypropylenes have a melt flow rate of not more than about 3500 dg/min, or not more than about 3000 dg/min, or not more than about 2500 dg/min, or not more than about 2000 dg/min, or not more than about 1000 dg/min, or not more than about 350 dg/min, or not more than about 100 dg/min. In one or more embodiments, polypropylenes have an MFR of from about 0.5 dg/min to about 2000 dg/min, or from about 1 dg/min to about 350 dg/min, or from about 1 dg/min to about 30 dg/min, or from about 10 dg/min to about 30 dg/min, and in other embodiments from about 1 dg/min to about 10 dg/min. In a preferred embodiment, polypropylenes have an MFR of from about 8 dg/min to about 2000 dg/min.

In some embodiments, polypropylenes have a Mooney viscosity [ML (1+4) @ 125° C.], as determined according to ASTM D1646, of less than about 100, or less than about 75, or less than about 60, and in other embodiments less than about 30.

Polypropylenes have a weight average molecular weight (Mw) of about 300,000 or less, preferably about 100,000 or less, preferably about 80,000 or less, preferably about 70,000 or less, more preferably about 60,000 or less, more preferably about 50,000 or less, more preferably about 40,000 or less, more preferably about 30,000 or less, more preferably about 20,000 or less, more preferably about 10,000 or less. In some embodiments Mw is also at least about 10,000, more preferably at least about 15,000.

In one embodiment, polypropylenes have a number average molecular weight (Mn) of less than about 50,000 g/moles, less than 40,000 g/mole, less than 30,000 g/mole, or less than 20,000 g/mole. In another embodiment, polpropylenes have an Mc of from about 2,500 to about 50,000 g/mole, or from about 5,000 to about 50,000 g/mole, or from about 10,000 to about 50,000 g/mole, and in other embodiments a Mn of from about 25,000 to about 50,000 g/mole.

The molecular weight distribution index (MWD=(Mw/Mn)) of polypropylenes is from about 1 to about 40, or from about 1 to about 5, or from about 1.8 to about 5, and in other embodiments from about 1.8 to about 3. Techniques for determining the molecular weight (Mn and Mw) and molecular weight distribution (MWD) may be found in U.S. Pat. No. 4,540,753, Verstrate et al., 21 Macromolecules, 3360 (1988), and T. Sun, P. Brant, R. R. Chance, and W. W. Graessley, Macromolecules, Volume 34, Number 19, 6812-6820, (2001), each of which is herein incorporated by reference in its entirety.

The propylene branching index, g′, is measured using Size Exclusion Chromatography (SEC) with an on-line viscometer (SEC-VIS) and are reported at each molecular weight in the SEC trace. The branching index g′ is defined as:

$${g}^{′} = \frac{{η}_{b}}{{η}_{l}}$$

where η_{b} is the intrinsic viscosity of the branched polymer, η₁ is the intrinsic viscosity of a linear polymer of the same viscosity-averaged molecular weight (Mv) as the branched polymer, η₁=KMᵥ^{α}, and K and α are measured values for linear polymers and should be obtained on the same SEC-DRI-LS-VIS instrument as the one used for branching index measurement.

For polypropylene samples provided herein, K=0.0002288 and α=0.705 were used. The SEC-DRI-LS-VIS method obviates the need to correct for polydispersities, since the intrinsic viscosity and the molecular weight are measured at individual elution volumes, which contain narrowly dispersed polymer. Linear polymers selected as standards for comparison should be of the same viscosity average molecular weight and comonomer content. Linear character for polymer containing C2 to C10 monomers is confirmed by Carbon-13 NMR the method of Randall (Rev. Macromol. Chem. Phys., C29 (2&3), p. 285-297).

For polypropylene samples provided herein, K=0.0002288 and α=0.705 were used. The SEC-DRI-LS-VIS method obviates the need to correct for polydispersities, since the intrinsic viscosity and the molecular weight are measured at individual elution volumes, which contain narrowly dispersed polymer. Linear polymers selected as standards for comparison should be of substantially the same viscosity average molecular weight and comonomer content. Linear character for polymer containing C2 to C10 monomers is confirmed by Carbon-13 NMR the method of Randall (Rev. Macromol. Chem. Phys., C29 (2&3), p. 285-297).

The size exclusion chromatograph is operated with three Polymer Laboratories PLgel 10 mm Mixed-B columns, a nominal flow rate 0.5 cm³/min, and a nominal injection volume 300 microliters is common to both detector configurations. The various transfer lines, columns and differential refractometer (the DRI detector, used mainly to determine eluting solution concentrations) are contained in an oven maintained at 135° C.

A typical LALLS detector is the model 2040 dual-angle light scattering photometer (Precision Detector Inc.). Its flow cell, located in the SEC oven, uses a 690 nm diode laser light source and collects scattered light at two angles, 15° and 90°. Only the 15° output was used in the following experiments. Its signal is sent to a data acquisition board (National Instruments) that accumulates readings at a rate of 16 per second. The lowest four readings are averaged, and then a proportional signal is sent to the SEC-LALLS-VIS computer. The LALLS detector is placed after the SEC columns, but before the viscometer.

A typical viscometer is a high temperature Model 150R (Viscotek Corporation). It consists of four capillaries arranged in a Wheatstone bridge configuration with two pressure transducers. One transducer measures the total pressure drop across the detector, and the other, positioned between the two sides of the bridge, measures a differential pressure. The specific viscosity for the solution flowing through the viscometer is calculated from their outputs. The viscometer is inside the SEC oven, positioned after the LALLS detector but before the DRI detector.

Solvent for the SEC experiment was prepared by adding 6 grams of butylated hydroxy toluene (BHT) as an antioxidant to a 4 liter bottle of 1,2,4 Trichlorobenzene (TCB)(Aldrich Reagent grade) and waiting for the BHT to solubilize. The TCB mixture was then filtered through a 0.7 micron glass pre-filter and subsequently through a 0.1 micron Teflon filter. There was an additional online 0.7 micron glass pre-filter/0.22 micron Teflon filter assembly between the high pressure pump and SEC columns. The TCB was then degassed with an online degasser (Phenomenex, Model DG-4000) before entering the SEC.

Polymer solutions were prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/ml at room temperature and 1.324 g/ml at 135° C. The injection concentration ranged from 1.0 to 2.0 mg/ml, with lower concentrations being used for higher molecular weight samples.

Prior to running each sample the DRI detector and the injector were purged. Flow rate in the apparatus was then increased to 0.5 ml/minute, and the DRI was allowed to stabilize for 8-9 hours before injecting the first sample. The argon ion laser was turned on 1 to 1.5 hours before running samples by running the laser in idle mode for 20-30 minutes and then switching to full power in light regulation mode.

The polypropylene branching index is less than about 1.0 measured at the Mz of the polymer. Preferably the branching index is about 0.95 or less, about 0.9 or less, about 0.85 or less, about 0.8 or less, about 0.7 or less, about 0.6 or less, 0.5 or less as measured at the Mz of the polymer.

In some embodiments propylene polymers have a peak melting point (Tm) between 40 and 250° C., or between 60 and 190° C., or between about 60 and 150° C., or between 80 and 130° C. In some embodiments the peak melting point is between 60 and 160° C. In other embodiments the peak melting point is between 124-140° C. In other embodiments the peak melting temperature is between 40-130° C.

In some embodiments propylene polymers have a viscosity (also referred to a Brookfield Viscosity or Melt Viscosity) of 90,000 mPa·sec or less at 190° C. (as measured by ASTM D 3236 at 190° C.); or 80,000 or less, or 70,000 or less, or 60,000 or less, or 50,000 or less, or 40,000 or less, or 30,000 or less, or 20,000 or less, or 10,000 or less, or 8,000 or less, or 5000 or less, or 4000 or less, or 3000 or less, or 1500 or less, or between 250 and 6000 mPa·sec, or between 500 and 5500 mPa·sec, or between 500 and 3000 mPa·sec, or between 500 and 1500 mPa·sec, and/or a viscosity of 8000 mPa·sec or less at 160° C. (as measured by ASTM D 3236 at 160° C.); or 7000 or less, or 6000 or less, or 5000 or less, or 4000 or less, or 3000 or less, or 1500 or less, or between 250 and 6000 mPa·sec, or between 500 and 5500 mPa·sec, or between 500 and 3000 mPa·sec, or between 500 and 1500 mPa·sec. In other embodiments the viscosity is 200,000 mPa·sec or less at 190° C., depending on the application. In other embodiments the viscosity is 50,000 mPa·sec or less depending on the applications.

In some embodiments propylene polymers have a heat of fusion of about 100 J/g or less, 70 J/g or less, or about 60 J/g or less, or about 50 J/g or less; or about 40 J/g or less, or about 30 J/g or less, or about 20 J/g or less and greater than zero, or about greater than 1 J/g, or greater than about 10 J/g, or between about 20 and about 50 J/g.

In some embodiments propylene polymers have a Shore A Hardness as measured by ASTM 2240 of about 95 or less, about 70 or less, or about 60 or less, or about 50 or less, or about 40 or less or about 30 or less, or about 20 or less. In other embodiments the propylene polymer has a Shore A Hardness of about 5 or more, about 10 or more, or about 15 or more. In certain applications, such as packaging, the Shore A Hardness is preferably about 60 to about 70.

In some embodiments propylene polymers have a Shear Adhesion Fail Temperature (SAFT), as measured by ASTM 4498, of about 200° C. or less, or from about 40 to about 150° C., or from about 60 to about 130° C., or from about 65 to about 110° C., or from about 70 to about 80° C. In other embodiments the polypropylene has a SAFT of from about 130 to about 140° C.

In some embodiments propylene polymers have a Dot T-Peel of between about 1 Newton and about 10,000 Newtons, or from about 3 and about 4000 Newtons, or between about 5 and about 3000 Newtons, or between about 10 and about 2000 Newtons, or between about 15 and about 1000 Newtons.

Dot T-Peel is determined according to ASTM D 1876, except that the specimen is produced by combining two 1 inch by 3 inch (2.54 cm×7.62 cm) Kraft paper substrate cut outs with a dot of adhesive with a volume that, when compressed under a 500 gram weight occupies about 1 square inch of area (1 inch=2.54 cm). Once made all the specimens are pulled apart in side by side testing (at a rate of 2 inches per minute) by a machine that records the destructive force of the insult being applied. The maximum force achieved for each sample tested was recorded and averaged, thus producing the Average Maximum Force which is reported as the Dot T-Peel.

In some embodiments propylene polymers have a crystallization point (Tc) between 20 and 110° C. In some embodiments the Tc is between 70 to 100° C. In other embodiments the Tc is between 30 to 80° C. In other embodiments the Tc is between 20 to 50° C.

In some embodiments propylene polymers have a melt index ratio (I10/I2) of 20 or less, preferably 10 or less, preferably 6.5 or less, preferably 6.0 or less, preferably 5.5 or less, preferably 5.0 or less, preferably 4.5 or less, preferably between 1 and 6.0. (I10 and I2 are measured according to ASTM 1238 D, 2.16 kg, 190° C.).

In another embodiment, propylene polymers have a melt index (as determined by ASTM 1238 D, 2.16 kg, 190 deg. C.) of 25 dg/min or more, preferably 50 dg/min or more, preferably 100 dg/min or more, more preferably 200 dg/min or more, more preferably 500 dg/min or more, more preferably 2000 dg/min or more.

Preferably, polyolefin compositions include at least about 50 wt. % propylene, preferably at least about 60% propylene, alternatively at least about 70% propylene, alternatively at least about 80% propylene, or at least about 90 weight percent propylene.

In some embodiments polyolefin compositions have an amorphous content of at least about 40 wt. %. Preferably, the polyolefin composition has an amorphous content of at least about 50 wt. %, alternatively at least about 60 wt. %, alternatively at least about 70 wt. %. In some embodiments the polyolefin composition has an amorphous content from about 50 wt. %, to about 99 wt. %. Percent amorphous content is determined using Differential Scanning Calorimetry measurement according to ASTM E 794-85.

In some embodiments polyolefin compositions have a crystallinity of about 40 wt. % or less. Preferably, the polyolefin composition has a crystallinity of about 30 wt. % or less, alternatively about 20 wt. % or less. In some embodiments, the polyolefin composition has a crystallinity of from about 5 wt. % to about 40 wt. % or from about 10 wt. % to about 30 wt. %. Percent crystallinity content is determined using Differential Scanning Calorimetry measurement according to ASTM E 794-85.

In some embodiments, polyolefin compositions have a molecular weight distribution (Mw/Mn) of at least 1.5, preferably at least 2, preferably at least 5, preferably at least 10, even alternatively at least 20. In other embodiments the Mw/Mn is 20 or less, 10 or less, even 5 or less.

In some embodiments polyolefin compositions have at least two molecular weight fractions present at greater than about 2 wt. %, preferably greater than about 20 wt. %, each based upon the weight of the polymer as measured by gel permeation chromatography (GPC). The fractions can be identified on a GPC trace by observing two distinct populations of molecular weights. For example, the weight fractions are confirmed as percent by a GPC trace showing a peak at 20,000 Mw and another peak at 50,000 Mw where the area under the first peak represents more than 2 wt. % of the polymer and the area under the second peak represents more than 2 wt. % of the polymer. One skilled in the art of gel permeation chromatography will recognize the many possible combinations of molecular weight fractions.

In some embodiments polyolefin compositions have about 20 wt. % or more of hexane room temperature soluble fraction, and about 70 wt. % or less, preferably about 50 wt. % or less of Soxhlet boiling heptane insolubles, based upon the weight of the polyolefin composition.

Soxhlet heptane insoluble refers to one of the fractions obtained when a sample is fractionated using successive solvent extraction technique. The fractionations are carried out in two steps: one involves room temperature solvent extraction, the other soxhlet extraction. In the room temperature solvent extraction, about one gram of polymer is dissolved in 50 ml of solvent (e.g., hexane) to isolate the amorphous or very low molecular weight polymer species. The mixture is stirred at room temperature for about 12 hours. The soluble fraction is separated from the insoluble material using filtration under vacuum. The insoluble material is then subjected to a Soxhlet extraction procedure. This involves the separation of polymer fractions based on their solubility in various solvents having boiling points from just above room temperature to 110° C. The insoluble material from the room temperature solvent extraction is first extracted overnight with a solvent such as hexane and heptane (Soxhlet); the extracted material is recovered by evaporating the solvent and weighing the residue. The insoluble sample is then extracted with a solvent having higher boiling temperature such as heptane and after solvent evaporation, it is weighed. The insolubles and the thimble from the final stage are air-dried in a hood to evaporate most of the solvent, then dried in a nitrogen-purged vacuum oven. The amount of insoluble left in the thimble is then calculated, provided the tare weight of the thimble is known.

In some embodiments, the polyolefin composition has a heptane insoluble fraction of about 70 weight % or less, based upon the weight of the starting polymer, and the heptane insoluble fraction has branching index g′ of 0.9 (preferably 0.7) or less as measured at the Mz of the polymer. In a preferred embodiment the composition also has at least about 20 weight % hexane soluble fraction, based upon the weight of the starting polymer. In another embodiment, the polyolefin composition has a heptane insoluble fraction of about 70 weight % or less, based upon the weight of the starting polymer and a Mz between 20,000 and 5000,000 of the heptane insoluble portion. In a preferred embodiment the composition also has at least 20 weight % hexane soluble fraction, based upon the weight of the starting polymer. In another embodiment the polymers produced have a hexane soluble portion of at least about 20 wt. %, based upon the weight of the starting polymer.

In some embodiments polyolefin compositions include propylene and from 0 to 50 mole % ethylene, preferably from 0 to 30 mole % ethylene, more preferably from 0 to 15 mole % ethylene, more preferably from 0 to 10 mole % ethylene, more preferably from 0 to 5 mole % ethylene.

In preferred embodiments polyolefin compositions include propylene and from 0 to 50 mole % butene, preferably from 0 to 30 mole % butene, more preferably from 0 to 15 mole % butene, more preferably from 0 to 10 mole % butene, more preferably from 0 to 5 mole % butene.

In preferred embodiments polyolefin compositions include propylene and from 0 to 50 mole % hexene, preferably from 0 to 30 mole % hexene, more preferably from 0 to 15 mole % hexene, more preferably from 0 to 10 mole % hexene, more preferably from 0 to 5 mole % hexene.

In preferred embodiments polyolefin compositions include terpolymers with propylene and from 0 to 70 mole % of butene and ethylene. In the terpolymer, butene can vary from 5 to 65 mole % and ethylene from 5 to 65 mole %.

Exemplary polyolefin compositions are composed of propylene homopolymers and copolymers composed of and, optionally, additional additives:

| | A | B | C | D | E |
|---|---|---|---|---|---|
| Propylene | 90.3-91.9 | 90.3-91.9 | 91.3-92.9 | 84.3-85.9 | 88.3-89.9 |
| Polymer | | | | | |
| Hexene as % | 0 | 9-11 | 9-11 | 5.4-6.6 | 9-11 |
| of Propylene | | | | | |
| Polymer | | | | | |
| Wax (wt. %) | 6.4-7.6 | 7.3-8.8 | 4.5-5.5 | 1.8-2.2 | 0 |
| Maleated | 1.3-1.5 | 0 | 1.8-2.2 | 0 | 4.55-5.45 |
| Polypropyl- | | | | | |
| ene (wt. %) | | | | | |
| Tackifier | 0 | 0 | 0 | 11-13 | 4.55-5.45 |
| (wt. %) | | | | | |

The propylene polymer component of exemplary compositions A-E preferably exhibit a branching index as described above and the following properties:

| | A | B | C | D | E |
|---|---|---|---|---|---|
| Melt | 750-1150 | 650-1000 | 650-1000 | 1500-2100 | 12000-17000 |
| Viscosity | | | | | |
| @ | | | | | |
| 190° C., | | | | | |
| (cps) | | | | | |
| Delta Hf | 35-45 | 35-47 | 35-47 | 18-24 | 12-16 |
| by DSC | | | | | |
| (KJ/Kg) | | | | | |
| Tm by | 110-140 | 110-135 | 110-135 | 95-115 | 85-110 |
| DSC, | | | | | |
| (° C.) | | | | | |

The exemplary compositions A-E preferably have the following properties:

| | A | B | C | D | E |
|---|---|---|---|---|---|
| Set Time, | 2.5 max | 2 max | 2.5 max | 3.5 max | — |
| (Seconds) | | | | | |
| Open Time, | ~20 | ~20 | ~26 | >40 | ~15 |
| (Seconds) | | | | | |

% Adhesion

| | | | | | |
|---|---|---|---|---|---|
| Room Temp. | >90 | >90 | >90 | >100, 3gsm | — |
| 0° C. | >50 | >50 | >90 | >400, 6gsm | — |
| −18° C. | >10 | >20 | >80 | — | >80 @ |
| | | | | | 6° C. |
| Delta Hf by DSC | 52-65 | 50-60 | 47-63 | 18-24 | 16-21 |
| (KJ/Kg) | | | | | |
| Softening Point, | 128-138 | 118-128 | 118-128 | 118-128 | 118-128 |
| (° C.) | | | | | |

Polyolefin compositions are prepared by any conventional synthesis processes. Preferably, polyolefin compositions are prepared utilizing one or more metallocene catalysts. One or more reactors may be utilized to prepare polymer compositions. Multiple reactors may be operated in series or in parallel. Reaction components, catalyst systems, and/or optional modifiers are added in batches or continuously as a solution or slurry. Catalyst system components are added either separately to the reactor, activated in-line just prior to the reactor, or preactivated and pumped as an activated solution or slurry to the reactor. A preferred method is two solutions activated in-line.

In single catalyst systems, polyolefin compositions containing amorphous and semi-crystalline components may be prepared in a single reactor to yield desired property balance. In particular, aPP-g-scPP branch structures may be produced in-situ in a continuous solution reactor.

In multiple catalyst systems, at least one catalyst is selected as being capable of producing essentially atactic polymer, e.g., atactic polypropylene, and at least one other catalyst is selected as being capable of producing isotactic polymer, isotactic polypropylene under the polymerization conditions utilized.

For propylene based systems, preferably, polymerization conditions yield incorporation of aPP and iPP polymer chains within the in-reactor blend such that an amount of amorphous polypropylene present in the POA polymer is grafted to isotactic polypropylene, represented herein as (aPP-g-iPP) and/or such that an amount of isotactic polypropylene is grafted to amorphous polypropylene, represented herein as (iPP-g-aPP). Preferably, the polymers are prepared in a solution phase, slurry, or bulk phase polymerization process.

In one embodiment, propylene polymers are prepared as a reactor blend using a multi catalyst system. A first catalyst is a stereorigid transition metal compound used to produce the semi-crystalline polypropylene macromonomers, which is selected from the group consisting of: (a) racemic bridged bis(indenyl) zirconocenes or hafnocenes, (b) racdimethylsilyl-bridged bis(indenyl) zirconocene or hafnocene, (c) rac-dimethylsilyl bis(2-methyl-4-phenylindenyl) zirconium or hafnium dichloride or dimethyl, (d) rac-dimethylsilyl-bridged bis(indenyl) hafnocene such as rac-dimethylsilyl bis(indenyl)hafnium dimethyl or dichloride. At least one additional catalyst used to produce amorphous polypropylene macromonomers is selected from the group consisting of: (a) 1,1′-bis(4-triethylsilylphenyl)methylene-(cyclopentadienyl)(2,7-di-tertiary-butyl-9-fluorenyl)hafnium dimethyl, (b) di(p-triethylsilylphenyl)methylene(cyclopentadienyl)(3,8-di-t-butylfluorenyl) zirconium dichloride, (c) di(p-triethylsilylphenyl)methylene(cyclopentadienyl)(3,8-di-t-butylfluorenyl) hafnium dichloride, (d) di(p-triethylsilylphenyl)methylene(cyclopentadienyl) (3,8-di-t-butylfluorenyl) zirconium dimethyl, or (e) di(p-triethylsilylphenyl)methylene (cyclopentadienyl)(3,8-di-t-butylfluorenyl) hafnium dimethyl.

Adhesives include conventional formulated adhesives and/or polymer based adhesives known to those skilled in the art. Adhesive compositions may include those conventional additives known in the art, such as waxes, tackifiers, fillers, antioxidants, adjuvants, adhesion promoters, plasticizers, natural waxes, synthetic waxes, oils, low molecular weight polymers, block, antiblock, pigments, processing aids, UV stabilizers, neutralizers, lubricants, surfactants nucleating agents, oxidized polyolefins, acid modified polyolefins, and/or anhydride modified polyolefins. Adhesive compositions may include the tacky polymer compositions described herein. Additives are combined with other adhesive components as individual components, in masterbatches, or combinations thereof.

Exemplary adhesives are described in U.S. Application Nos. 60/418,482, filed Oct. 15, 2002, 60/460,714, filed Apr. 4, 2003, Ser. No. 10/687,508, filed Oct. 15, 2003, Ser. No. 10/686,951, filed Oct. 15, 2003, Ser. No. 10/825,380, issued as U.S. Pat. No. 7,223,822, Ser. No. 10/825,635, filed Apr. 15, 2004, Ser. No. 10/825,349, filed Apr. 15, 2004, and Ser. No. 10/825,348, filed Apr. 15, 2004, 61/076,467, filed Jun. 27, 2008, each of which is herein incorporated by reference in its entirety.

Exemplary adhesive compositions are commercially available from ExxonMobil Chemical Co. as the LINXAR™ adhesive family of products.

In one or more embodiments, tacky compositions are generally adhesives and/or adhesive polymers that have a low viscosity and/or a low degree of crystallinity and/or solidify slowly. These tacky compositions generally have a Ring and Ball Softening Point between about 80° C. and 160° C. according to ASTM E28 and a Brookfield Thermosel Viscosity between about 200 and 60,000 centipoise (cP) at 190° according to ASTM D3236. These tacky compositions preferably have a Ring and Ball Softening Point between about 85° C. and 140° C., a viscosity between about 500 and 20,000 cp at 190° C., and a glass transition temperature (Tg) below 0° C. according to ASTM D3418.

Hydrocarbon resins, i.e., tackifiers, include conventional hydrocarbon resins known to those skilled in the art. Exemplary tackifiers include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, and hydrogenated rosin esters. In some embodiments the tackifier is hydrogenated. In other embodiments the tackifier is non-polar. Non-polar means that the tackifier is substantially free of monomers having polar groups.

Waxes include natural or synthetic waxes, e.g., beeswax, Fischer Tropsch waxes including oxidized forms, polar or non-polar waxes, polypropylene waxes, polyethylene waxes, wax modifiers, paraffin or petroleum wax, polyolefin wax, polyethylene wax, maleated polyethylene waxes, and high density low molecular weight polyethylene or HDLMWPE.

In one embodiment, the tacky composition comprises a polyolefin composition comprising a propylene polymer having: (a) a Dot T-Peel of 1 Newton or more on Kraft paper, (b) a Mw of 10,000 to 100,000, and (c) a branching index (g′) of: (i) from 0.4 to 0.98 measured at the Mz of the polyolefin when the polyolefin has an Mw of 10,000 to 60,000, or (ii) from 0.4 to 0.95 measured at the Mz of the polyolefin when the polyolefin has an Mw of 10,000 to 100,000.

In one embodiment, the tacky composition comprises a polyolefin composition comprising a propylene-hexene copolymer having: (a) a Dot T-Peel of 1 Newton or more on Kraft paper, (b) a Mw of 10,000 to 100,000, (c) a branching index (g′) of: (i) from 0.4 to 0.98 measured at the Mz of the polyolefin when the polyolefin has an Mw of 10,000 to 60,000, or (ii) from 0.4 to 0.95 measured at the Mz of the polyolefin when the polyolefin has an Mw of 10,000 to 100,000, and (d) a hexene comonomer content of less than 25 wt. %.

In one embodiment, the tacky composition comprises a polyolefin composition comprising a propylene-octene copolymer having: (a) a Dot T-Peel of 1 Newton or more on Kraft paper, (b) a Mw of 10,000 to 100,000, and (c) a branching index (g′) of: (i) from 0.4 to 0.98 measured at the Mz of the polyolefin when the polyolefin has an Mw of 10,000 to 60,000, or (ii) from 0.4 to 0.95 measured at the Mz of the polyolefin when the polyolefin has an Mw of 10,000 to 100,000.

### Antiblock Compositions

Antiblock compositions inhibit particle blocking i.e., caking, agglomerating, aggregating and/or sticking, when at least partially coated on the surface of particles in a sufficient amount. Antiblock compositions include powders, silicones, surfactants, waxes, polymers, and combinations thereof.

Antiblock compositions include organic or inorganic compounds such as those selected from the group consisting of talc, mica, calcium carbonate, finely divided or fumed silica, organic acids, metal organic esters, cellulose derivatives, alumina trihydrate, marble dust, cement dust, clay, feldspar, alumina, magnesium oxide, magnesium hydroxide, antimony oxide, zinc oxide, barium sulfate, aluminum silicate, calcium silicate, titanium dioxide, titanates, chalk, powdered polymers, or combinations thereof. Some antiblock compositions exhibit a TMA of greater than 75° C., such as powdered polyethylene, polystyrene, and polypropylene. The aforementioned antiblocking compositions may be employed in purified form or in mixtures. The antiblocking compositions may be employed in any form; however, powders are generally preferable.

Preferably, the antiblock composition is a polymeric powder, a salt of an organic acid, e.g. calcium stearate, or combination thereof. Exemplary antiblock compositions are composed of Ligafluid, which is a calcium stearate dispersion commercially available from Peter Greven Fett-Chemie. Another exemplary antiblock composition is polyethylene powder such as low density polyethylene, which is commercially available as HA2454 from E.I. Du Pont De Nemours and Company. In alternative embodiments combinations of Ligafluid and HA2454 are utilized.

Tacky compositions are contacted with an effective amount of antiblock composition. The quantity of an effective amount depending upon the anti-blocking agent, tacky composition polymer, and temperature of each composition when contacted. It is not necessary that each particle or pellet be totally covered with anti-blocking agent. In addition, it is not necessary that every particle be covered with any anti-blocking agent. Usually, the particles are sufficiently coated such that the average amount of surface coating is above about 50 percent. Typically, an effective amount of anti-blocking agent is that amount which decreases the unconfined yield strength of the tacky composition by at least about 20 percent, preferably by at least about 30 percent or at least about 50 percent. In some embodiments, the unconfined yield strength of the tacky composition is decreased by about 100 percent or more, or even by about 1000 percent or more.

In some embodiments the tacky composition is substantially coated with at least about 0.05 wt. %, based on the total weight of the tacky composition particles. Preferably, the tacky composition is substantially coated with at least about 0.1 wt. %, or at least about 0.3 wt. %, or at least about 0.5 wt. %, or at least about 0.7 wt. %, or at least about 0.8 wt. %, or at least about 1.0 wt. %, or at least about 1.5 wt. %, based on the total weight of the tacky composition particles.

### Methods

Methods for preparing agglomeration resistant particles include the steps of: providing tacky composition particles, increasing the tackiness of the tacky composition particles, e.g., increasing ambient temperature, and contacting the tacky composition particles with an antiblock composition so that the tacky composition particles are at least partially coated with the antiblock composition.

Tacky material may be coated several different ways, including simple admixing, agitation, tumbling, airveying, strand pelletizing, under water pelletizing, and combinations thereof. Exemplary blending equipment/processes include any mechanical means of moving the pellets such as simple tumbling, or blending in a conical rotating vessel, ribbon blender, drum tumbler, paddle blender, agglomeration pan, fluidized bed pneumatic conveyor under air or inert gas, stirring, shaking, screw conveyor or mixing pellets through recirculation in vessels (e.g. silos). Strand pelletizing processes extrude tacky materials into strands that are then dusted and cut into pellets.

The tacky composition and the antiblock agent are contacted at any temperature that does not cause the antiblock agent to evaporate, or become too viscous, or significantly react with the tacky composition. Such temperatures often vary depending upon the components of the composition but typically are from about −10 to about 200° C., or from about 0 to about 150° C., or from about 30 to about 100° C. In some embodiments, the antiblock composition and the tacky composition are contacted at a temperature above about 25° C. or above about 30° C., or above about 35° C., or above about 50° C., or above about 60° C., or above about 70° C. In other embodiments, the antiblock composition and the tacky composition are contacted at a temperature of from about 25° C. to about 75° C. or from about 25° C. to about 50° C. or from about 25° C. to about 40° C. In embodiments, where the tacky composition is crystallizable, the tacky composition and the antiblock agent are preferably contacted at temperature that induces crystallization in the tacky composition.

In one embodiment, methods for preparing agglomeration resistant particles contact the tacky composition and the antiblock composition at a temperature near or above the glass transition temperature (Tg) of the tacky composition. Thus, the tacky composition and antiblock composition are contacted at Tg of the tacky composition, or 5° C. or more above Tg, or 10° C. or more above Tg, or 15° C. or more above Tg, or 20° C. or more above Tg.

In one embodiment, methods for preparing agglomeration resistant particles contact the tacky composition and the antiblock composition at a temperature near or above the Ring and Ball softening temperature of the tacky composition. Thus, the tacky composition and antiblock composition are contacted at the Ring and Ball softening temperature of the tacky composition, or 5° C. or more above, or 10° C. or more above, or 15° C. or more above, or 20° C. or more above the Ring and Ball softening temperature of the tacky composition.

In one or more embodiments, the present methods prepare particles of tacky material that are substantially pourable, free-flowing particles that resist blocking. “Pourable” means the coated particles will flow through a funnel and yield a pourability value (according to ASTM D1895 Method B) both initially and after elevated temperature storage. Preferably, the free flowing particles have an initial pourability value of less than about two seconds, or less than about 1.8 seconds, or less than about 1.6 seconds, or less than about 1.5 seconds, or less than about 1.4 seconds.

Preferably, the tacky composition and the antiblock composition are contacted while immersed in a first fluid, e.g., underwater pelletizing apparatus. For example, the tacky composition, or components thereof, is charged into a vessel or an extruder to be melted, sheared, and/or mixed. The vessel may be at atmospheric pressure, pressurized, or under vacuum and may be unpurged or purged with air or an inert gas such as nitrogen, argon, etc. Pressure, vacuum, and purging, if any, may be applied sequentially or continuously in any combination and order. The requisite energy converts the formulation to a molten or semi-solid mixture or liquid which flows suitably by gravity or under pressure when released in batch processing or continuous flow processing. The applied energy may be thermal and/or mechanical in the form of low, medium, or high shear as necessitated by the formulation requirements which directly and significantly impacts the temperature of the molten, semi-solid or liquid tacky composition.

The temperature of the first fluid may vary depending upon the components of the composition but typically are from about −10 to about 200° C., or from about 0 to about 150° C., or from about 30° C. to about 100° C. In some embodiments, the temperature of the first fluid is above about 25° C. or above about 30° C., or above about 35° C., or above about 50° C., or above about 60° C., or above about 70° C. In other embodiments, the first fluid are contacted at a temperature of from about 25° C. to about 75° C. or from about 25° C. to about 50° C. or from about 25° C. to about 40° C. In embodiments, where the tacky composition is crystallizable, the temperature of the first fluid is at a temperature that induces crystallization in the tacky composition.

In one embodiment, the temperature of the first fluid is near or above the glass transition temperature (Tg) of the tacky composition. Thus, the temperature of the first fluid is at the Tg of the tacky composition, or 5° C. or more above Tg, or 10° C. or more above Tg, or 15° C. or more above Tg, or 20° C. or more above Tg.

In one embodiment, the temperature of the first fluid is near or above the Ring and Ball softening temperature of the tacky composition. Thus, the tacky composition and antiblock composition are contacted at the Ring and Ball softening temperature of the tacky composition, or 5° C. or more above, or 10° C. or more above, or 15° C. or more above, or 20° C. or more above the Ring and Ball softening temperature of the tacky composition.

For example, the tacky composition is extruded to an underwater pelletizer where it contacts a first fluid that includes the antiblock composition. Underwater pelletizing includes the steps of extruding the tacky material through the orifice of a die plate that is immersed in a first fluid that contains the antiblock composition, cutting said plastic material as it is extruded while in contact with the first fluid to form particles coated with the antiblock composition, and separating the particles from the first fluid. Exemplary underwater pelletizers are taught by U.S. Pat. Nos. 4,569,810 and 4,663,099, the disclosures of which are incorporated herein by reference in their entirety.

In an underwater pelletizer, a pressurized melt of tacky composition proceeds through a thermally regulated die toward a vessel containing the first fluid. The tacky composition passes through the die and is cut by rotating blades in the pelletizing unit. Thermally controlled first fluid removes pellets from the cutter blade and transports them through an agglomerate catcher for removal of coarse and/or oversized pellets. The pellets are dewatered, by for example a centrifugal dryer or fluidized bed, to remove surface moisture from the pellets.

As those skilled in the extrusion art recognize, water temperature, rotational speed of the extruder cutter blades, and the flow rate of the melt through an extrusion die effect pellet geometries. The pellet temperature, both interior and the exterior, i.e., shell, also influence the pellet formation and drying.

Additional conventional processes may be utilized before or after drying, such as coating, enhanced crystallization, cooling operations, or other processing appropriate to the pelletized material.

The amount of antiblock composition present in the first fluid is sufficient to substantially coat the tacky composition particles as they contact the first fluid but yet not sufficient to interfere with processing. When water is the first fluid, the amount of antiblock composition is typically less than about 5% by weight of the water. Preferably, the antiblock composition is present in less than about 2 wt. %, or less than about 1.5 wt. %, or less than about 1.0 wt. %, or less than about 0.9 wt. %, or less than about 0.75 wt. %, based on the weight of water.

Optionally, once separated from the first fluid, the tacky composition particles may be contacted with additional antiblock composition. The antiblock composition utilized in the first fluid may be the same or different from the additional antiblock composition.

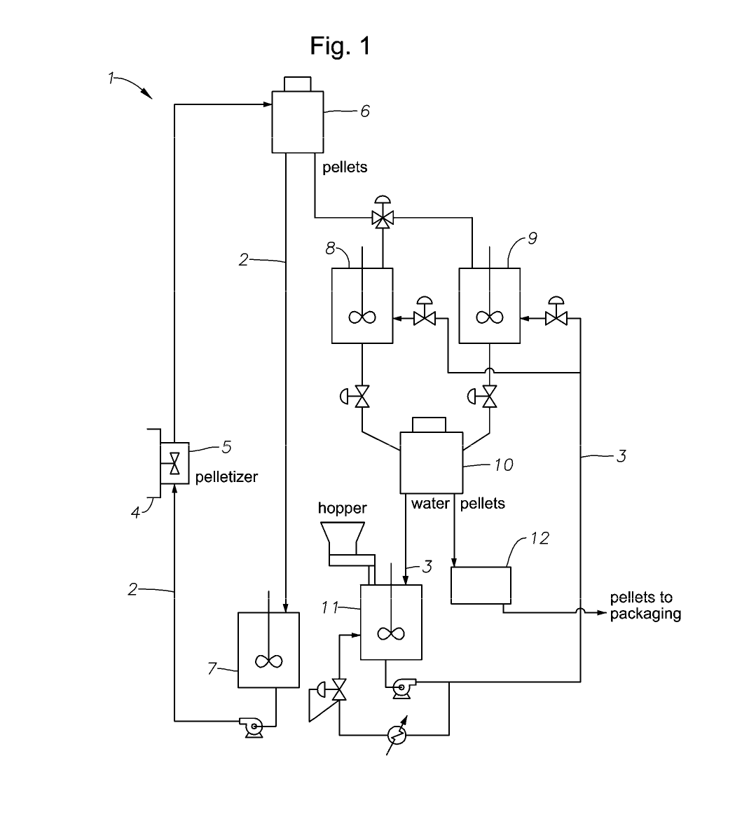

FIG. 1 is a schematic diagram of an exemplary apparatus for preparing agglomeration resistant particles. The apparatus 1 shows a pelletizer liquid loop 2, i.e., water loop 2, operated with an additional warm liquid loop 3, i.e., warm water loop 3, to elevate pellet temperature while contacting the pellets with antiblock compositions. Water loop 2 is maintained at a temperature below the temperature of warm water loop 3. An exemplary temperature for water loop 2 is about 5 to about 10° C.

Referring to FIG. 1, a tacky composition is prepared and transported to an extruder 4, which maintains favorable operating temperature. The extruder 4 is connected to an underwater pelletizing apparatus 5 that pelletizes the tacky composition and contacts the tacky composition with a first fluid, e.g., water. From the underwater pelletizing apparatus 5, the pellets travel to a drying apparatus 6, e.g., spin dryer, which removes excess water. The excess water removed from the pellets is optionally looped back to the underwater pelletizing apparatus 5 via pelletizer water loop 2 and antiblock reservoir 7.

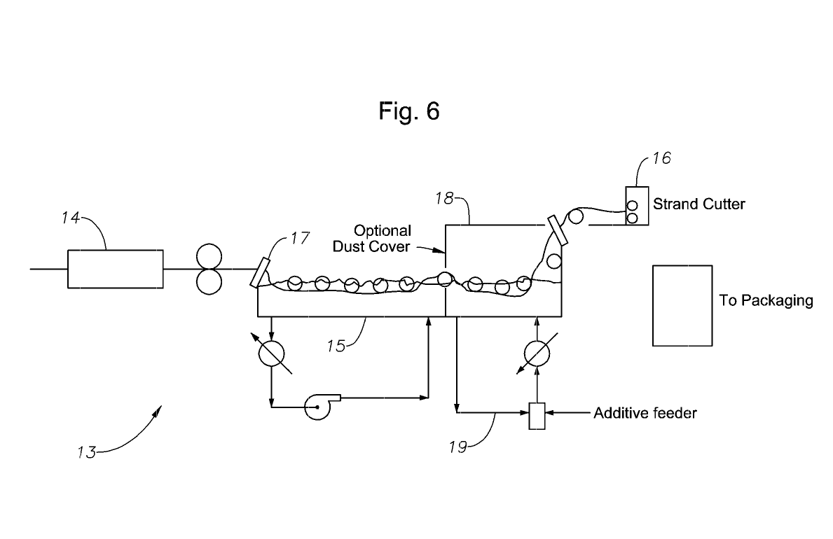

Pellets are transported from spin dryer 6 to one or more stirred tanks 8 and 9, which contain additional additives, including optionally the same and/or a different antiblock composition. Although two stirred tanks are shown in FIG. 6, one stirred tank may be utilized as an alternative. If multiple stirred tanks are utilized, the apparatus can be operated in a semi-batch state. Pellets are processed in stirred tank 8, thereby removing additive compositions to coat pellets, while a second stirred tank 9 is filled with water and additive compositions. The flow of pellets is then alternated to the newly filled second stirred tank 9 thereby permitting the first stirred tank 8 to be refilled with water and additive compositions.

When contacted with warm water from the warm water loop 3 in the stirred tanks 8 and 9, the pellets simultaneously warm up, harden, and become coated with additives, e.g., antiblock composition. Pellets dusted/coated while at elevated temperature are less susceptible to loss of dust upon cooling and storage. Less free dust generation is generally preferred due to safety and or housekeeping concerns, e.g., the effect dust can have on the electrical hazard classification of the processing area. As a further safety precaution and as an alternative to the apparatus of FIG. 1, additives, such as antiblock composition, could be added to water in a separate tank in a safe/dust free location and then circulated into storage tank 11.

From the stirred tanks 8 and 9, the pellets are transported to a second drying apparatus 10, e.g., spin dryer, which removes excess water. The excess water removed from the pellets is optionally looped back to a storage tank 11 via warm water loop 3, which maintains proper concentration of additives in the water feed and stirred tanks 8 and 9. Water loop 3 is maintained at above about 10° C., or above about 30° C., or at or above about 50° C., or above about 75° C.

The pellets travel from the second drying apparatus 10 to a cooling apparatus 12, where they are cooled, e.g., to ambient temperature or near ambient temperature, and prepared for packaging.

Certain low viscosity tacky materials, e.g., amorphous polyolefins, are less likely to plug process equipment, e.g., heat exchanger or extrusion dies. Therefore, just prior to extrusion, these materials may optionally be cooled to a temperature below their Ring and Ball softening point to aid in forming solid particles. For example, such materials may be cooled down to about 10° C. or 20° C. or 30° C. below their Ring and Ball softening point without producing a significant pressure drop in processing equipment.

FIG. 6 is a schematic diagram of another exemplary apparatus for preparing agglomeration resistant particles. Such an apparatus may replace a cooling extruder configuration as described in U.S. Patent Application No. 60/986,515, which is herein incorporated by reference in its entirety.

Referring to FIG. 6, a strand cutting apparatus 13 includes a melt cooler 14, vessel 15 for holding a cooling liquid and option additives, and a strand cutter 16. First, a molten polymer stream travels to a melt cooler 13, which forms a solid or semi-solid strand. The polymer strand is optionally passed though rollers to a die 14. Preferably, the polymer strand exits the die 14 at an angle of from about 0 to about 90 degrees measured from parallel to vessel 15.

From the die, the polymer strand passes through vessel 15 having one or more zones for contacting the polymer strand with a cooling fluid, e.g., water, and optional additives, e.g., antiblock composition. As shown in FIG. 6, vessel 15 includes two zones, wherein only the second zone contains antiblock composition. However, the antiblock composition may be present in one or more of a multiple zone vessel. The vessel 15 or portions thereof may optionally be covered with a dust cover 18. Optionally, an air knife removes excess fluid and/or antiblock composition. Preferably, any excess antiblock composition that is recycled to vessel 15 via recycle loop 19. From vessel 15 the polymer strand travels to a strand cutter 16 where the polymer is cut into pellets.

Preferably, vessel 15 includes more than one zone, i.e., stage, where liquid temperature is either increased or decreased to induce polymer crystallization, dusting, and drying. For example, in one embodiment a first zone is maintained at about 20 to about 30° C., or about 25° C. A second zone for dusting is maintained at about 40 to about 50° C. or about 45° C., and a third zone for cooling is maintained at about 20 to about 35° C. or about 30° C.

In other embodiments, also provided are:

A. A method for preparing agglomeration resistant particles comprising the steps of:

a. providing tacky composition particle having an unconfined yield strength of at least about 15 lbs/ft² at or above 25° C. as measured by ASTM D6773,

b. increasing the tackiness of the tacky composition particles by contacting the tacky composition particle with a first fluid at a temperature at least about 25° C., and

c. while the tacky composition particles are in contact with the first fluid at a temperature at least 25° C., contacting the tacky composition particles with an antiblock composition,

wherein the tacky composition particles are at least partially coated with the antiblock composition.

B. The method for preparing agglomeration resistant particles of embodiment A, wherein the tacky composition comprises a polyolefin composition comprising at least 75 weight percent propylene, base on the weight of the polymer composition.

C. The method for preparing agglomeration resistant particles of embodiment B, wherein the polyolefin composition has a branching index (g′) of 0.95 or less measured at the Mz of the polymer and the tacky composition particles are contacted with a the first fluid at a temperature at least about 25° C. above the glass transition temperature of the tacky composition.

D. The method for preparing agglomeration resistant particles of embodiment B or C, wherein the polymer composition comprises propylene and a comonomer selected from the group consisting of butane, hexene, octane, or combinations thereof.

E. The method for preparing agglomeration resistant particles of any of embodiments B-D, wherein the polyolefin composition has:

a) an isotactic run length of 1 to 30,

b) a percent of r dyad of greater than 20%, and

c) a heat of fusion of between 1 and 70 J/g.

F. The method for preparing agglomeration resistant particles of any of embodiments A-E, wherein the first fluid is an aqueous based fluid.

G. The method for preparing agglomeration resistant particles of any of embodiments A-F, wherein the first fluid is an aqueous based fluid at a temperature from about 25° C. to about 75° C.

H. The method for preparing agglomeration resistant particles of any of embodiments A-G, wherein the tacky composition particles are pellets.

I. The method for preparing agglomeration resistant particles of any of embodiments A-H, wherein the first fluid is substantially free of surfactant.

J. The method for preparing agglomeration resistant particles of any of embodiments A-I, wherein the tacky composition particles contact the first fluid in an underwater pelletizer.

K. The method for preparing agglomeration resistant particles of any of embodiments A-J, wherein the tacky composition particles contact the first fluid in a fluidized bed.

L. The method for preparing agglomeration resistant particles of any of embodiments A-K, wherein the antiblock composition is a polymer, salt of an organic acid, or combinations thereof.

M. The method for preparing agglomeration resistant particles of any of embodiments A-L, wherein the antiblock composition is a polymeric powder.

N. The method for preparing agglomeration resistant particles of any of embodiments A-M, wherein the adhesive composition particles are substantially free flowing in less than 90 seconds, or less than 60 seconds, or less than 45 seconds, or less than 30 seconds, or less than 15 seconds, or less than 10 seconds without an applied force after being stored at 45° C. for three days in a three inch vessel with 3500 grams of applied pressure as described in ASTM D1895 Method B.

O. The method for preparing agglomeration resistant particles of any of embodiments A-N, wherein the adhesive composition particles have a crystallization half life of less than six minutes at 15° C.

P. The method for preparing agglomeration resistant particles of any of embodiments A-O, wherein the adhesive composition particles have a crystallization half life of less than two minutes at 30° C.

Q. The method for preparing agglomeration resistant particles of any of embodiments A-P, wherein after contacting the first fluid, the polymer composition particles are coated with from about 0.01 to about 3.0 weight percent antiblock composition based on the weight of the agglomeration resistant particles.

R. The method for preparing agglomeration resistant particles of any of embodiments A-Q, wherein the agglomeration resistant particles are prepared in a continuous process such that, before being contacted with the first fluid, the polymer composition is polymerized and maintained at a temperature above about 25° C. without cooling below about 25° C.

S. The method for preparing agglomeration resistant particles of any of embodiments A-R, wherein the tacky composition is any of exemplary polyolefin compositions A-E as described at paragraphs 65-67.

T. A method of transporting an agglomeration resistant particles comprising:

a polyolefin composition having an unconfined yield strength of at least about 15 lbs/ft² at or above 25° C. as measured by ASTM D6773, the method comprising the steps of:

a. providing particles of the polymer composition at or above the glass transition temperature of the polymer composition,

b. increasing the tackiness of the polymer composition particles by contacting the polymer composition particle with a first fluid at a temperature at least about 25° C., and

c. while the adhesive composition particles are in contact with the first fluid at a temperature at least 25° C. above the glass transition temperature of the polymer composition, contacting the polymer composition particles with an antiblock composition, wherein the polymer composition particles are at least partially coated with the antiblock composition.

U. The method for preparing agglomeration resistant particles of any of embodiments A-L, wherein the antiblock composition is a low density polyethylene.

V. The method for preparing agglomeration resistant particles of any of embodiments A-L, wherein the antiblock composition is a polymer.

Certain features of the present invention are described in terms of a set of numerical upper limits and a set of numerical lower limits. It should be appreciated that ranges from any lower limit to any upper limit are within the scope of the invention unless otherwise indicated.

The above description is intended to be illustrative, and should not be considered limiting. Persons skilled in the art will recognize that various modifications may be made without departing from the spirit and scope of the invention. Accordingly, this description will be deemed to include all such modifications that fall within the appended claims and their equivalents.

### EXAMPLES

The following examples, which are not intended to be limiting, present certain embodiments and advantages of the present compositions and methods. Unless otherwise indicated, all percentages are on a weight basis.

### Example 1

A tacky composition, Composition A, was prepared and pelletized in a simple tank. The pellets' resistance to agglomeration was observed at room temperature and at elevated temperatures.

Composition A was composed of about 88.3-89.9 wt. % propylene-hexene copolymer, about 4.55-5.45 wt. % maleated polypropylene, about 4.55-5.45 wt. % tackifier, and an antioxidant. The propylene-hexene copolymer had a hexene content of about 9-11 wt. %. The propylene copolymer exhibited a Melt Viscosity @ 190° C. of about 9720 cps, a Delta Hf as measured by DSC of 26 KJ/Kg. Pellets of Composition A were dusted with high density polyethylene.

Composition A was prepared, extruded, pelletized, spun dried, and then sent to a simple tank for dusting. The tank was filled with water and supplied by a heated water loop. The tank was not agitated other than by the movement of heated water. The tank turnover rate was about once per minute. Water temperature and antiblock content for various runs are reported in Table 1:

TABLE 1

| | | Water Antiblock |
|---|---|---|
| | Water Temp. | Content |
| | (° F.) | (wt. %) |
| Run 1 | 38 | 0.07 |
| Run 2 | 38 | 0.32 |
| Run 3 | 38 | 0.44 |
| Run 4 | 50 | 0.36 |
| Run 5 | 63 | 0.34 |
| Run 6 | 96 | 0.19 |

The resulting pellets were substantially dusted. The dusted pellets were tested for agglomeration resistance using ASTM D1895 Method B. Accordingly, the pellets were stored at 45° C. for three days in a three inch vessel with 3500 grams of applied pressure. The tubes were opened after three days, rated according to how quickly the pellets yielded and whether pressure was required to break up any observed agglomeration. Pellets pelletized at 100° F. (38° C.) received a rating 1, i.e., collapsed while unwrapping. Pellets pelletized at 110° F. (43° C.) received a rating of 1.5, i.e., fell apart on their own in less than 10 seconds. Pellets pelletized at 120° F. (49° C.) received a rating of 3, i.e., agglomerated, but fell apart by tapping with finger.

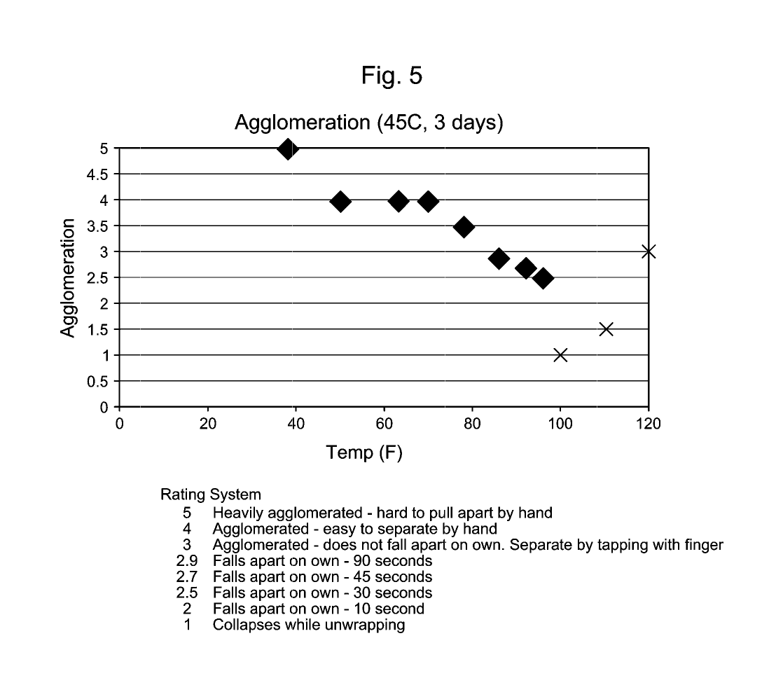

As shown in FIG. 5, the pellets pelletized at a higher water temperature were less susceptible to agglomeration. The pellets pelletized at a higher temperature became free flowing faster, i.e., did not need to be forced/picked apart. The pellets pelletized at a lower temperature were agglomerated and did not achieve a free flowing state after time.

### Example 2

A tacky composition, Composition B, was prepared, pelletized under water with an antiblock composition in the pelletizer water, and then dusted with a second antiblock composition. The pellets' resistance to agglomeration was observed at room temperature and at elevated temperatures.

Composition B was composed of about 88.3-89.9 wt. % propylene-hexene copolymer, about 4.55-5.45 wt. % maleated polypropylene, about 4.55-5.45 wt. % tackifier, and an antioxidant. The propylene-hexene copolymer had a hexene content of about 9-11 wt. %. The propylene copolymer exhibited a Melt Viscosity @ 190° C. of about 9800 cps and a Delta Hf as measured by DSC of about 21 KJ/Kg.

The antiblock composition in the underwater pelletizer was a calcium stearate dispersion commercially available as Ligafluid from Peter Greven Fett-Chemie. Pellets were subsequently dusted with a low density polyethylene, which is commercially available as HA2454 from E.I. Du Pont De Nemours and Company.

Using an apparatus configuration shown in FIG. 1, Composition B pellets where pelletized. The Ligafluid imparted a 0.1 wt. % calcium stearate coating over a substantial portion of the pellets' surface. During three runs, the dusting water loop was maintained at 100° F. (38° C.), 110° F. (43° C.), and 120° F. (49° C.) respectively. The dusting water loop was charged with 6.3 lbs of dust for the three runs. No additional dust was added for runs two and three.

The resulting pellets were substantially dusted. The dusted pellets were tested for agglomeration resistance using ASTM D1895 Method B. Accordingly, the pellets were stored at 45° C. for three days in a three inch vessel with 3500 grams of applied pressure. Referring to FIG. 5, Pellet samples were collected and placed in a three inch tube at 45° C. and 3500 grams pressure. The tubes were opened after three days, rated according to how quickly the pellets yielded under pressure as described in Example 1.

Without being limited by theory, the pellets prepared at 120° F. (49° F.) appear to be an anomaly caused by inadequately maintained dust levels in the pelletizer water loop water, i.e., not charging the dust level at the start of each run, poor mixing, wax softening, or combinations thereof.

It is theorized that pelletizing at 120° F. (49° C.) and higher temperatures using the same apparatus could be achieved by providing a higher concentration of dust in the dusting tank water, agitating the dusting tank, and/or using a higher melting point polymer.

### Example 3

The testing procedure of Example 2 was modified by using a different antiblock composition. The pellets' resistance to agglomeration was observed at room temperature and at elevated temperatures.

Using an apparatus configuration shown in FIG. 1, Composition B pellets where prepared and coated with calcium stearate as described in Example 2 and then contacted with a heated water loop at about 50° C. The heated water loop contained an additional antiblock composition. In a first run, the heated water contained an ethylene bisstearamide wax, which is commercially available as Acrawax C from Lonza Group. In a second run, the heated water contained a low density polyethylene, which is commercially available as HA2454 from E.I. Du Pont De Nemours and Company.

The pellets were dried over night at ambient temperature and subjected to oven aging under load at 50° C. for 3 days. After oven aging, the pellets were cooled to ambient temperature and removed from a heating vessel described in ASTM testing procedures. The extent of agglomeration, if any, was observed. Results are provided in Table 2:

TABLE 2

| | | Amount Of | | | Extra Weight |
|---|---|---|---|---|---|
| | Type of | Antiblock In | Oven | | Required To |
| | Antiblock In | Heated Water | Temp. | Days In | Collapse Pellets |
| Sample | Heated Water | (wt. %) | (C.°) | Oven | After Removal (g) |
| Composition A | Atomized | 0.3 | 50 | 3 | 0 |
| w/ 0.1 CaSt | Acrawax C | | | | (collapsed ~15 |
| from Ligafluid | | | | | seconds after |
| | | | | | removal) |
| Composition A | Low density | 1.0 | 50 | 3 | 0 |
| w/ 0.1 CaSt | polyethylene | | | | (collapsed a few |
| from Ligafluid | powder | | | | seconds after |
| | | | | | removal) |

As shown in Table 2, dusting the Composition B with both calcium stearate and low density polyethylene powder yielded favorable results, i.e., the pellets separated quickly with no force added to break them apart. It was observed that the pellets prepared with LDPE powder made a more uniform coating of the pellets compared to dry dusting techniques or wet dusting at room temperature. Without being limited by theory, it is believed that the elevated-temperature water causes a small portion of the polymer crystalline phase to melt at or near the pellet surface and become tacky thereby improving dusting.

It was observed that varying the pelletizer water loop temperature could lead to difficulty in forming pellets, i.e., the polymer should exit the die with sufficient viscosity to cut cleanly. Without being limited by theory, it is believed that the pelletizer water has limited effect on pellet cutting because very little heat can be transferred in the fraction of a second that it takes pellets to exit the extruder die hole. In contrast, pelletizing water temperature will have a greater impact on pellets over the next few seconds following cutting because the pellets leave the cutting area and move into the pelletizer water loop. In instances were the pellets were not coated quickly, they exhibited a greater susceptibility to agglomeration.

In addition to having a more uniform coating, the pellets exhibited faster crystallization and hardening compared to other dry or wet dusting techniques. Faster hardening pellets may be exposed to a load sooner after pelletizing thereby facilitating packaging. Moreover, packaging warm pellets prevented atmospheric moisture from condensing on the pellets thereby limiting concerns related to packaging wet pellets.

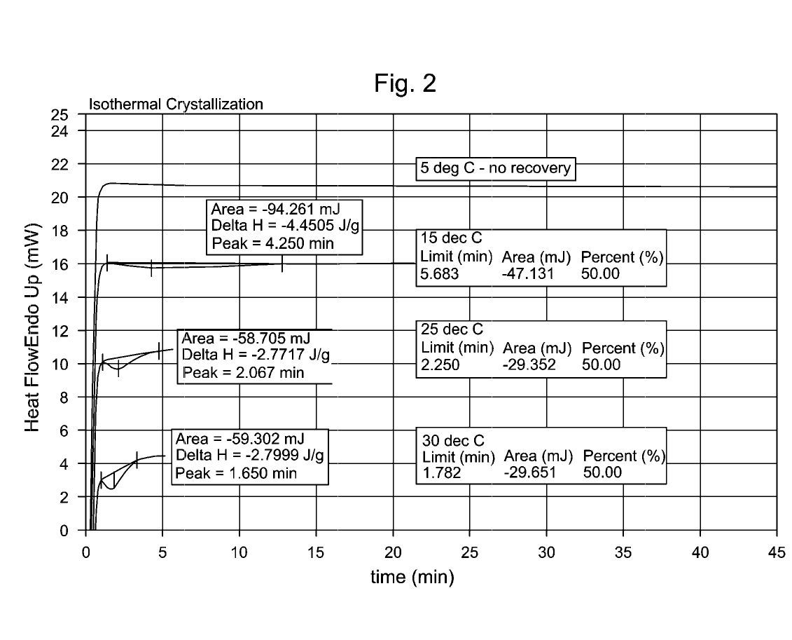

As shown in FIG. 2 and referring to Table 3, isothermal DSC testing of Composition B shows that crystallization half-life decreases as pelletizing water temperature increases.

TABLE 3

| | Temperature | Crystallization Half-life of |
|---|---|---|
| Series | (C.°) | Composition B (Minutes) |
| 1 | 0 | >45 |
| 2 | 15 | 5.7 |
| 3 | 25 | 2.3 |
| 4 | 30 | 1.8 |

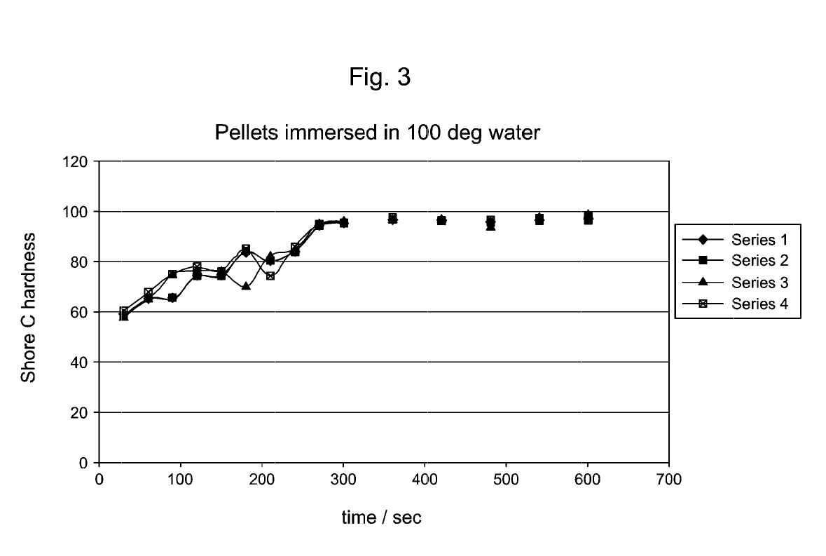

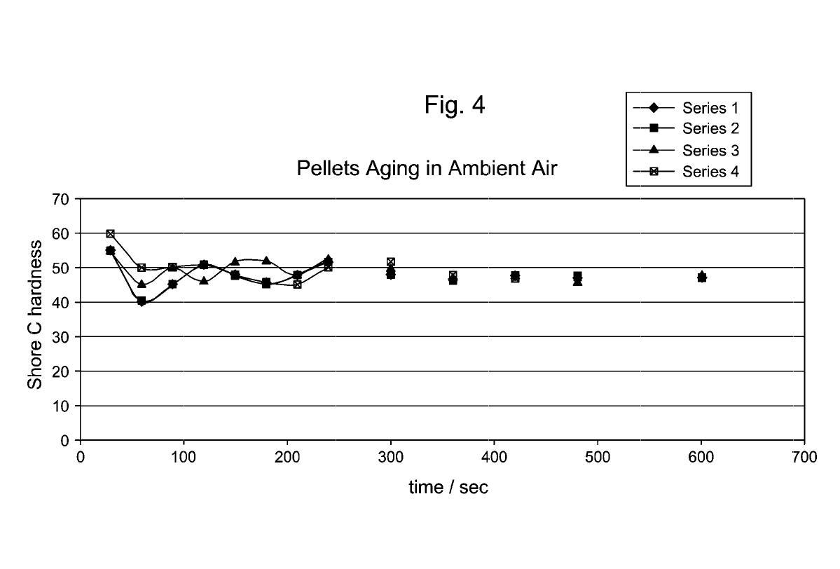

As shown in FIGS. 3 and 4, favorable hardening properties were exhibited.

### Example 4

Two tacky compositions, Composition C and Composition D, were prepared and pelletized using a strand cutting apparatus.

Composition C was composed of about 90.3-91.9 propylene homopolymer, about 6.4-7.6 wax, about 1.3-1.5 maleated polypropylene. The propylene homopolymer exhibited a Melt Viscosity @ 190° C. of about 1048 cps.

Composition D was composed of about 88.3-89.9 wt. % propylene-hexene copolymer, about 4.55-5.45 wt. % maleated polypropylene, about 4.55-5.45 wt. % tackifier, and an antioxidant. The propylene-hexene copolymer had a hexene content of about 9-11 wt. %. The propylene copolymer exhibited a Melt Viscosity @ 190° C. of about 10,667 cps.

Referring to FIG. 6, pellets of Composition C were prepared using a wet cut water slide pelletizer. The pelletizing apparatus consisted of a twin screw extruder with pellet feed system, die head, water slide system, pelletizer, and spin dryer. The water slide was ten feet long and had five spray stations along the length of the water slide. The sprays provided extra cooling and pushed the polymer strand down into the water flow so that the polymer did not float. It was generally observed that better heat transfer was possible if the polymer strand was submerged.

During a first series of runs using Composition C, the extruder was maintained at 236° F. This run produced uniform cylindrical pellets that were slightly flattened. Without being limited by theory, it is believed that the flattened shape was due to the pressure exerted on the polymer strand by the pelletizer feed rollers. The uncut strands were uniformly round. The pellets were spun dried. Pellet size was 2.5 g/50 pellets.

At higher temperatures, die head pressure decreased which reduced back mixing. At such temperatures small quantities of unmelted pellets were observed. Die head pressure was increased by using different size die heads.

In alternative configuration, a ten foot water bath extension was added to increase cooling. No spray stations were utilized on the extended water bath. The following combinations of melt temperatures, die sizes and pellets sizes were prepared:

TABLE 5

| Melt Temperature | Die Hole Size | Pellet Size | |
|---|---|---|---|
| (F.) | (mm) | (g/50 pellets) | Notes |
| 236 | 3 | 2.5 | Uniform cylindrical |
| | | | pellets |
| 242 | 4.5 | 1.0 | Uniform flattened |
| | | | pellets |
| 259 | 6.5 | None | Too soft to cut |
| 260 | 4.5 | 0.9 w/ variation | Flat pellets |
| 263 | 3 | 0.2 | Uniform flat pellets |

In a second series of runs using Composition D, the extruder melt temperature was 270 F. Consistent uniform strands were prepared, but the strands were too soft to pelletize. Two ten foot sections were added to the water bath for a 29 foot total length. The extension sections did not utilize spray stations. With the longer water bath, Composition D was pelletized. In an alternative configuration, the pelletizer feed rolls were sped up to stretch and thin the strand to further promote strand cooling.

As shown by the experiments of Example 4, a strand cutting device may be used to pelletize tacky compositions.

### Example 5

A tacky composition, Composition E, was prepared, pelletized under water and then dusted with a antiblock composition while Composition E is in contact with the palletizing water. The pellets' resistance to agglomeration was observed at elevated temperatures.

Composition E was composed of about 99.5 wt. % propylene-hexene copolymer and an antioxidant. The propylene-hexene copolymer had a hexene content of about 9-11 wt. %.

The dust used for this experiment was DuPont Coathylene HA2454 (low density polyethylene). The initial charge was 1 wt % of the pellet water inventory wherein the dust was added over the period of one hour. The target temperature for the start of pelletization was 100° F. (38° C.). Dust was continually added to match approximately 1 wt % of the extruder output. During the pelletization period pellet water temperature was adjusted over a range of 85 to 105° F. (29 to 41° C.) to see the effect of the temperature.

Referring to FIG. 1, the HA2454 was added to antiblock reservoir 7 and the liquid loop 2 was held at approximately 85 to 105° F. (29 to 41° C.) during the experiment. The antiblock reservoir 7 was equipped with a separate IKA pump in which to add the HA2454. Additionally, the antiblock reservoir 7 was equipped with an agitator turbine to keep the HA2454 sufficiently suspended in solution. No other antiblock was added to the system. Water from the spin dryers 6 was returned to the antiblock reservoir at the top of the reservoir. Conversely, the flow to the pelletizer 5 was taken from the bottom of the antiblock reservoir to keep any HA2454 that may be floating at the top of the reservoir from plugging the lines. Furthermore, the pellets exited the spin dryers 6 and bypassed the remainder of the equipment shown in FIG. 1. The pellets were then sent to packaging. In other words, in this example, the wet dusting occurred in one step wherein the HA2454 was added to the pelletizing water that makes direct contact with the underwater pelletizing apparatus 5 and no other antiblock agent was used either before or after the HA2454 pellet contact.

TABLE 6

| | Dust in water | Water | Pellet Size | Dust on pellets |
|---|---|---|---|---|
| Time | (wt %) | Temperature | (g/50) | (wt %) |
| 10:05 am | | | | |
| 10:55 am | 0.4 | 95.5 | 1.8 | 0.65 |
| 11:20 am | 0.62 | 89.9 | 4.5 | 0.39 |
| 11:35 am | 0.5 | 95 | 4.5 | 0.12 |
| 11:55 am | 0.67 | 97.5 | 4.6 | 0.48 |
| 12:15 pm | 0.7 | 104.8 | 4.4 | 0.28 |
| 12:40 pm | 0.73 | 88.7 | 4.6 | 0.52 |

Table 6 shows that the dust concentration on the pellets ranged from 0.12 to 0.65 wt %.

Agglomeration of Composition E was tested in two ways: (i) short term testing of fresh pellets at ambient conditions and (ii) long term testing of aged pellets under heat. For the short term testing, two samples of fresh pellets were collected at the outlet of the spin dryer and immediately placed in PVC tubes with compressing weights equivalent to the load of two stacked 500 kg supersacks. These tubes were allowed to sit for a day under the load and then the bottoms were opened up. When this was done, the pellets flowed freely out which indicates that there would be no problem with wet-dusted pellets agglomerating as they completed their crystallization and hardened in their package.

Long term testing was done in a similar manner as the short term testing wherein the samples were poured into PVC tubes and placed under load. A sample of Composition E using the Ligafluid, a calcium stearate dispersion, was also set up as a control. The loaded tubes were placed in a 55° C. oven for two weeks, removed, and allowed to cool. The PVC tube was then removed from around the pellet sample with the compressing load still in place. This left free-standing columns of agglomerated pellets supporting the compressing weights. The amount of time required for the column of pellets to collapse under the load was then measured which are shown in Table 7. Also, the comparative sample is shown wherein only calcium stearate was used as an antiblock with no HA2454 was added.

TABLE 7

| | | | Time in | |
|---|---|---|---|---|
| | Dust on pellets | Oven | oven | Time to collapse |
| Time | (wt %) | Temperature | (days) | (min) |
| 11:55 am | 0.48 | 55 | 8 | 6 |
| 12:15 pm | 0.28 | 55 | 14 | 11 |
| 12:40 pm | 0.52 | 55 | 14 | 12 |
| Comparative | 0.05 wt % CaSt | 55 | 14 | Would not |
| | from Ligafluid | | | collapse; heavily |
| | | | | agglomerated |

What is claimed is:

1. A method for preparing agglomeration resistant particles comprising the steps of:
a. providing tacky composition particles having an unconfined yield strength of at least about 15 lbs/ft² at or above 25° C. as measured by ASTM D6773,
b. increasing the tackiness of the tacky composition particles by contacting the tacky composition particle with a first fluid at a temperature of at least about 25° C., and
c. contacting the tacky composition particles with an antiblock composition while the tacky composition particles are in contact with the first fluid wherein the first fluid is at a temperature of at least 25° C.,
wherein the tacky composition particles are at least partially coated with the antiblock composition.

2. The method for preparing agglomeration resistant particles of claim 1, wherein the tacky composition comprises a polyolefin composition comprising at least 75 weight percent propylene, base on the weight of the polymer composition.

3. The method for preparing agglomeration resistant particles of claim 2, wherein the polyolefin composition has a branching index (g′) of 0.95 or less measured at the Mz of the polymer and the tacky composition particles are contacted with a the first fluid at a temperature at least about 25° C. above the glass transition temperature of the tacky composition.

4. The method for preparing agglomeration resistant particles of claim 2, wherein the polymer composition comprises propylene and a comonomer selected from the group consisting of butane, hexene, octane, or combinations thereof.

5. The method for preparing agglomeration resistant particles of claim 2, wherein the polyolefin composition has:
a) an isotactic run length of 1 to 30,
b) a percent of r dyad of greater than 20%, and
c) a heat of fusion of between 1 and 70 J/g.

6. The method for preparing agglomeration resistant particles of claim 1, wherein the first fluid is an aqueous based fluid.

7. The method for preparing agglomeration resistant particles of claim 1, wherein the first fluid is an aqueous based fluid at a temperature from about 25° C. to about 75° C.

8. The method for preparing agglomeration resistant particles of claim 1, wherein the tacky composition particles are pellets.

9. The method for preparing agglomeration resistant particles of claim 1, wherein the first fluid is substantially free of surfactant.

10. The method for preparing agglomeration resistant particles of claim 1, wherein the tacky composition particles contact the first fluid in an underwater pelletizer.

11. The method for preparing agglomeration resistant particles of claim 1, wherein the tacky composition particles contact the first fluid in a fluidized bed.

12. The method for preparing agglomeration resistant particles of claim 1, wherein the antiblock composition is a polymer, salt of an organic acid, or combinations thereof.

13. The method for preparing agglomeration resistant particles of claim 1, wherein the antiblock composition is a polymer.

14. The method for preparing agglomeration resistant particles of claim 1, wherein the antiblock composition is a polymeric powder.

15. The method for preparing agglomeration resistant particles of claim 1, wherein the antiblock composition is a low density polyethylene.

16. The method for preparing agglomeration resistant particles of any claim 1, wherein the adhesive composition particles are substantially free flowing in less than 90 seconds without an applied force after being stored at 45° C. for three days in a three inch vessel with 3500 grams of applied pressure as described in ASTM D1895 Method B.

17. The method for preparing agglomeration resistant particles of claim 1, wherein the adhesive composition particles have a crystallization half life of less than six minutes at 15° C.

18. The method for preparing agglomeration resistant particles of claim 1, wherein the adhesive composition particles have a crystallization half life of less than two minutes at 30° C.

19. The method for preparing agglomeration resistant particles of claim 1, wherein, after contacting the first fluid, the polymer composition particles are coated with from about 0.01 to about 3.0 weight percent antiblock composition based on the weight of the agglomeration resistant particles.

20. The method for preparing agglomeration resistant particles of claim 1, wherein the agglomeration resistant particles are prepared in a continuous process such that, before being contacted with the first fluid, the polymer composition is polymerized and maintained at a temperature above about 25° C. without cooling below about 25° C.

21. A method of transporting an agglomeration resistant particles comprising:
a polyolefin composition having an unconfined yield strength of at least about 15 lbs/ft² at or above 25° C. as measured by ASTM D6773, the method comprising the steps of:
a. providing particles of the polymer composition at or above the glass transition temperature of the polymer composition,
b. contacting the polymer composition particle with a first fluid at a temperature of at least about 25° C., and
c. contacting the polymer composition particles with an antiblock composition while the polymer composition particles are in contact with the first fluid,
wherein the polymer composition particles are at least partially coated with the antiblock composition.
